(19) United States
(12) Patent Application Publication
(10) Pub. No.: US 2022/0127433 A1
(43) Pub. Date: Apr. 28, 2022

(54) DURABLE RETROREFLECTIVE OPTICAL ELEMENTS

(71) Applicant: Potters Industries, LLC, Wilmington, DE (US)

(72) Inventors: Govindasamy Paramasivam Rajendran, Garnet Valley, PA (US); Jeffrey Lee Stricker, Narberth, PA (US)

(21) Appl. No.: 16/949,266

(22) Filed: Oct. 22, 2020

(51) Int. Cl. C08K 9/06; G02B 5/128; C08K 3/40; C08K 3/34; B29D 11/00

(52) U.S. Cl. CPC C08K 9/06; G02B 5/128; B29K 2509/08; C08K 3/34; B29D 11/00615; C08K 3/40

(57) ABSTRACT

A retroreflective optical element is provided in which modified glass beads having a high refractive index are embedded on the surface of a thermoplastic core. The glass beads are heated to a temperature near the softening point of the thermoplastic core and the heated beads and thermoplastic cores are mixed in a fluidized bed. The beads embed into the thermoplastic core and are also chemically bonded thereto through a silane coupling agent provided on the beads.

### BACKGROUND OF THE INVENTION

### Field of the Invention

The present disclosure relates to an optical element comprising a tough and reactive thermoplastic core and a surface modified higher refractive index glass beads embedded on the thermoplastic core and a process to make such elements.

### Background of the Related Art

Pavement or road markings, such as paints, tapes, and individual articles, guide and direct motorists and pedestrians along the roadways and paths. These markings form stripes, bars and markings that delineate lanes, crosswalks, parking spaces, symbols, legends and the like. Paints and thermoplastic melts are used for making these lines. Light reflective glass beads are spread on these markings for improving the visibility and retroreflectance.

Such retroreflective elements described in the prior art may be simple glass beads or a composite beads based on a core embedded with high refractive index glass beads. These elements may be formed completely from inorganic materials or from a combination of an organic-based core embedded with inorganic glass beads. Completely inorganic retroreflective elements are described in U.S. Pat. Nos. 5,917,652 and 5,942,280. Although these elements provide sufficient resistance to weathering and road chemicals, they are prohibitively expensive for road marking because of the cumbersome process and high temperature required to make these beads.

Another type of retroreflective element is based on a thermoplastic core and the glass beads embedded on the core. These retroreflective elements can be prepared by various methods, such as by dropping a liquid resin on a bed of optical elements or by casting a liquid resin mixed with glass optical elements in to a desired shape and followed by spraying the exposed surfaces with additional glass optical elements and then hardening the resin.

U.S. Pat. No. 5,750,191 describes a process for making retroreflecting elements by combining a bed of optical elements with one or more core elements comprising a thermoplastic material and agitating the combination for sufficient time and at sufficient temperature to coat the glass beads on to the core.

U.S. Pat. No. 6,247,818 teaches a method to make retroreflective elements comprising a core layer, a reflective layer, a spacing layer and on top of it a layer containing retroreflective elements.

U.S. Pat. Nos. 7,156,528 and 7,458,693 report methods of making retroreflecting elements from preformed retroreflective sheeting having a viewing surface with the opposing surface of the sheeting being laminated with a shrinkable layer. The laminate can be cut into desirable sizes which, due to the shrinkable layer, curl into different shapes. These sheets can be used as retroreflective elements.

U.S. Pat. No. 7,820,083 B2 teaches a process of extruding a thermoplastic, pigments and glass beads into pellets, then immersing the pellets in a suitable liquid that dissolves and removes the surface layer, exposing the glass beads on the surface for retroreflection. Though the extrusion is a simple process, the additional steps of immersing the pellet in an organic solvent and washing away the polymer on the surface of the pellet to expose the glass beads makes the total process complex, and increases the cost of these elements.

U.S. Pat. Application No. 2018/0291175 discloses a retroreflective element which includes a thermoplastic core containing one set of glass beads and a second set of glass beads embedded on the core. The glass beads in the thermoplastic core and the beads embedded on the core may be the same or different, the embedded glass beads have a higher refractive index.

The optical elements, based on a thermoplastic core with embedded glass beads, have to be durable, tough and the glass beads strongly bonded to the core. In the thermoplastic core the organic binder is the continuous medium which is in contact with the embedded inorganic glass beads. There is no strong bonding between the core and the embedded glass beads. The embedded glass beads strip away over time due to environmental conditions such as from road salt and rain and due to engagement by the wheels of the vehicle, reducing the visibility of the road markers over time. None of the prior art teaches any attempt to make the organic and inorganic interphase stronger to withstand the service conditions.

In addition, the thermoplastic core has to be sufficiently tough, and not brittle, to withstand the continuous wear in high traffic conditions. The thermoplastic core has a higher amount of inorganic materials such as pigments, glass beads and inert fillers. Such material systems tend to be more brittle. Therefore there is a necessity to increase the toughness of the thermoplastic. U.S. Pat. No. 5,750,191 reports the use of reactive monomers, i.e., thermoset resins, in the core to make generally tougher thermoplastic cores. The presence of reactive monomers in a thermoplastic may be suitable for making tough coatings. However, controlling the crosslinking reactions and the consequent increase in the viscosity of the material is rather difficult to control in an extrusion process. Moreover, the increase in the viscosity affects the glass beads embedment to sufficient depth on the thermoplastic core.

Although many of these elements reported in the prior art are useful, they do not effectively bond the glass beads to the thermoplastic core to prevent the stripping away of the embedded beads. They also do not provide a simple method to toughen the high inorganic particulates containing thermoplastic core. Thus a need still exists for retroreflective elements an improved way of making tough thermoplastic core and glass beads chemically bonded to the thermoplastic core.

### BRIEF SUMMARY OF THE INVENTION

The disclosed invention includes an optical element that is retroreflective under dry and wet conditions, and a method for making such elements. The optical element includes a reactive and tough thermoplastic core which is retroreflective and surface modified high refractive index glass beads embedded on the thermoplastic core. The thermoplastic core contains reflective glass beads which may be different from the embedded beads on the core surface. The glass beads included in the thermoplastic makes the core retroreflective after the embedded reflective beads wear away. The ingredients in the thermoplastic core and the surface modifying glass beads have suitable organic functional groups that react with each other to form a stable bond in short time to make the optical elements. The chemical bond formed between the thermoplastic core and the beads improves the durability of the optical elements for application in road marking applications.

The method of making the optical elements comprises heating the surface modified glass beads to a temperature closer to the softening point of the thermoplastic core in a fluidized bed or similar heating and mixing devices and mixing with thermoplastic core pellets maintained at ambient condition for few minutes, isolating the optical elements from the free glass beads. This process condition is conducive for the reaction between the functional groups in the thermoplastic core and the glass beads to take place. This reaction produces a stable chemical bond between the core and the embedded beads.

### BRIEF DESCRIPTION OF THE DRAWINGS

FIG. 1 is a cross-sectional view of the thermoplastic core of the present invention.

FIG. 2 is a cross-sectional view of the optical element of the present invention.

### DETAILED DESCRIPTION OF THE INVENTION

While the present invention will be described with reference to the following ingredients, it will be understood by those skilled in the prior art that various changes may be made and equivalents may be substituted without departing from the scope of the invention. In addition, many modifications may be made to adapt a particular situation or material to the teachings of the invention without departing from the essential scope thereof. It is therefore intended that the present invention not be limited to the particular embodiments disclosed as the best mode contemplated for carrying this invention, but that the invention will include all embodiments and legal equivalents thereof which are within the scope of the appended claims.

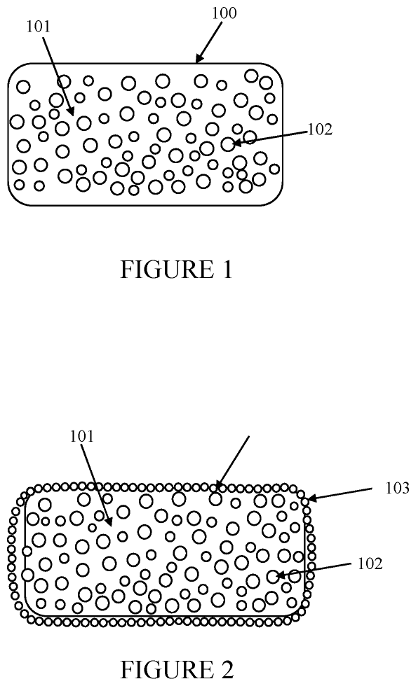

As shown in FIGS. 1 and 2, the present invention is a retroreflective optical element comprising a tough and reactive thermoplastic core 100 which is embedded with surface modified high refractive index beads 103. The thermoplastic core 100 is preferably a tough and reactive thermoplastic matrix dispersed with pigments and inert fillers as shown in 101. Glass beads 102 are dispersed uniformly in the thermoplastic matrix for continued retroreflectivity even after the surface embedded beads are worn out. The size and refractive index of these glass beads may be different from the embedded glass beads 103 on the core surface.

The glass beads 103 embedded on the thermoplastic core 100 preferably have higher refractive index, narrow size distribution and are surface modified with silane coupling agents. In this element, the high refractive index beads 103 are bound to the thermoplastic core 100 through chemical bonding and thermomechanical forces so that a substantially higher amount of beads 103 are still bound to the thermoplastic core 100; and retain a higher amount of retroreflectivity after subjecting the optical elements, spread on the top of a paint coating, with a harsh wet abrasive testing. This is a standard practice used in the laboratory for evaluating the performance of the road markings.

The optical elements described in the invention are substantially covered by the reflective elements 103, such elements embedded to sufficient depth on the core and chemically bonded to the core. The reflective elements 103 cover uniformly the thermoplastic core 100 without any void spaces on the core 100, and the coverage should be at least more than 50%, and preferably more than 90%, of the projected surface area of the core. The preferred depth of embedment of the reflective beads 103 on the core 100 is 30 to 70%, and preferably 40 to 60%, of the diameter of the glass beads. The embedment of the glass beads 103 to more than 70% of the diameter reduces the retroreflectivity of the element. Reflective beads embedded less than 30% of their diameter have a tendency to easily dislodge from the thermoplastic core. The reflective glass beads 103 embedded on the core 100 have a narrow distribution of sizes. Because of the size differences, the smaller beads sink completely or more than 70% of the size on the thermoplastic core surface by the time the larger beads embed to half the sizes, making the smaller beads not active for retroreflection.

The optical elements made using this invention are substantially cylindrical in shape. These elements can be transformed into spherical or disc shaped materials using controlled heat treatment. These elements have narrow distribution of sizes and flow under the influence of gravity so that these can be conveyed through hoppers and other instruments used in the uniform spreading of the elements on the road markings.

The thermoplastic core comprises polymeric binders, plasticizer, flow additives, organic and inorganic pigments; and inert fillers such as calcium carbonate, glass dust and glass beads. The polymeric binders preferably include an alkyd resin or a hydrocarbon resin, which is the main component of the binder. The polyethylene wax, oil and ethylene copolymer are present in small amounts. The plasticizer is a naturally occurring organic oil, such as castor oil. The pigments include titanium oxide, which is commonly used for white and yellow line markings, as well as other organic pigments that are added to produce the required color for the road markings. The inert fillers are calcium carbonate or glass dust, mostly added to reduce the cost of the elements. Glass bead is also added to reduce the cost and maintain retroreflectivity even after the embedded glass bead is removed by the road traffic.

Suitable alkyd resins include rosin resin, which is comprised of one or more components consisting of modified rosin resins and rosin esters. Modified rosin resins are comprised of one or more components consisting of rosin acids, maleic anhydride and fumaric acid. Rosin acid is derived from pine trees as gum rosin, wood rosin and tall oil rosin. Rosin esters are comprised of one or more derivatives obtained from the reaction of one or more rosin acids and one or more alcohol from the group of alcohols consisting of methanol, ethanol, tri-ethylene glycol, glycerol and penta-erythritol. The hydrocarbon resin is a mixture of aliphatic and aromatic resins. These resins are based on C5 chain structure and hydrogenated for use in adhesives, tackifiers and as a wax in rubber manufacturing. These resins do not contain any organic functional groups.

Suitable plasticizers include vegetable oils and phthalates. Vegetable oils are the reaction products of the fatty acids with glycerol, commonly referred to as triglycerides; castor oil is a typical example. Phthalates are comprised of one or more components from a group of esters such as dimethyl phthalate, diethyl phthalate, dibutyl phthalate, dicyclohexyl phthalate, butyl(2-ethylhexyl) phthalate and similar such phthalate ester compounds.

The waxes are used in the thermoplastic composition to improve the flow and anti-blocking modification. These include petroleum-derived waxes and synthetic waxes. The petroleum-derived waxes are comprised of one or more member selected from the group containing saturated n-alkanes, iso-alkanes, naphthenes, alkyl substituted aromatic compounds, and naphthene substituted aromatic compounds. Synthetic waxes can be polyethylene, Fischer-Tropsch waxes, chemically modified waxes or amide-modified waxes. Polyethylene waxes generally have the chemical formula (C₂H₄)ₙH₂ and can have either linear or branched chain structures. The waxes can be based on ultra-high molecular weight polyethylene (UHMWPE) high-density polyethylene (HDPE), medium density polyethylene, linear low-density polyethylene (LLDPE), low-density polyethylene (LDPE) and very low density polyethylene (VLDPE). Fischer-Tropsch waxes generally have the chemical formula CₙH₍₂ₙ₊₂₎. The chemically modified waxes are converted from non-polar to polar additive by the incorporation of functional groups such as hydroxyl, carboxyl, a salt, an ester and an acid group. Amide modified waxes have amide functional molecules grafted to the polyethylene chain to modify flexibility or adhesion or compatibility with other binder components.

Ethylene copolymer is included in the thermoplastic composition to improve the durability and the flow modification of the thermoplastic cores. Suitable examples include ethylene vinyl acetate copolymers, ethylene acrylate copolymers, ethylene methacrylate copolymers, ethylene acrylate glycidyl-acrylate copolymers. The amount of ethylene unit can range from 50% to 95% by weight and the remaining the other monomer in the copolymer. The preferred copolymer is ethylene-vinyl acetate. The vinyl acetate content can vary from 2% to 30% by weight in the copolymer. The ethylene acrylic or methacrylic acid may be also used in making the thermoplastic core, but is usually avoided because the acid groups in the copolymers can react with the inert fillers added to reduce the cost of the element. For example, the acid group reacts with the calcium carbonate which affects the viscosity and melt processability of the thermoplastic composition. Additionally the reaction of acid groups with calcium carbonate results in calcium bicarbonate which can diffuse out of the thermoplastic cores, leaving a filler rich surface for the thermoplastic core.

The compositions of this invention can comprise one or more fillers. Useful fillers are typically solids that are non-reactive with the other components of the compositions of this invention. The fillers constitute the major portion of the composition, comprising 70% to 85% by weight of the total composition. Useful fillers include clay, talc, glass particles and beads, metal oxide and sulfate particulates, ceramic microspheres, hollow polymeric or glass microspheres, carbonates, silica and aluminum trihydrate.

The filler can include coloring pigments. Rutile titanium dioxide with a minimum purity of 92% is usually used for white materials and a combination of titanium oxide and organic or heavy metals free pigment is usually used for yellow materials. Barium sulfate or zinc oxide can also be used in place of titanium oxide in these compositions. The filler can also include ground calcium carbonate or magnesium carbonate with or without organic surface treatment. The particle size of these carbonates is selected based on the flow requirements of the thermoplastic composition. A glass fill can be used as an inert filler to adjust the viscosity of the formulation.

The particular glass beads used as a filler in the thermoplastic core depends on the applicable governmental requirement for the size, quality, amount and retro-reflectivity. The beads are microspheres of glass or ceramic that are retroreflective and have a diameter of 150 to 850 microns. The glass beads provide continuous retro-reflectivity for extended periods due to the core materials. As the embedded beads removed from the core due to the high traffic conditions and the core material wears off, the glass beads in the thermoplastic composition are exposed, providing continued reflectivity for the road markings.

The ingredients for the core can be melt mixed and processed into pellets of desired length and width using the conventional thermoplastic processing techniques. The dry mixtures containing the fillers, thermoplastic binders, glass beads and pigment can be mixed in the form of particulates or pellets and fed into an extruder for melt mixing to form a strand of well mixed material. The pigment and the plasticizer can be premixed with one or more binder ingredients and added as powders or pellets of a pigmented thermoplastic material if desired. The strand is extruded at a temperature above the melt temperature of the thermoplastic material, cooled and then cut into small pieces as pellets. The extrusion temperature is not so high above the melt temperature of the thermoplastic as it affects the color and thorough dispersion of the fillers into the binder and self-supporting capability of the strand. These conditions can be readily determined by one of skilled in the art. The extrusion of the thermoplastic materials described in the invention is carried out in the range 80° C. to 220° C. The extrusion can be carried out in a single or twin screw extruder.

### Toughness of the Thermoplastic Core

The thermoplastic core of the present invention typically comprises from 10 to 30 weight percent organic binders and the rest inorganic materials such as inert fillers, glass beads and pigments. The properties of the particulate filled polymer composites are generally determined by the component properties, relative amounts of the organic and inorganic components, and the interaction between the phases. The thermoplastic core of this invention comprises of low molecular weight polymers due to the constraints of the required properties such as low softening point, moderate viscosity, flow, resistance to salt, oil and grease materials. Also large amount of particulates such as inert fillers and glass beads are added to the core to reduce the cost. The fillers and glass beads have higher surface energy and the binders have lower surface energy. Such a heterogeneous material combination has poor interphase between the organic and inorganic phases. The material systems tend to be more brittle. Though the prior art teaches surface modification of the fillers and glass beads with suitable organic compounds, silane and titanate coupling agents, the surface modification of the fillers increases the cost of the ingredients. The prior art also reported, in the U.S. Pat. No. 5,750,191, the use of thermoset resins in the core to improve the toughness of the thermoplastic. The thermoset polymer is usually more brittle than thermoplastic polymer. The addition of reactive monomers has a tendency to increase the cross link density and the brittleness of the resultant product. Additionally these materials may be difficult to process in conventional thermoplastic processing techniques because of the difficulty in controlling the crosslinking reaction and the consequent increase in the melt viscosity due to crosslinking. There is a need to improve the toughness of the thermoplastic core without increasing the cost and proportion of binders in the core material, and also without increasing the melt viscosity and softening point.

Among the binders present in the thermoplastic core, the largest molecular weight material is the ethylene copolymer. The ethylene copolymer provides durability and flow modification to the thermoplastic core. Suitable examples include ethylene vinyl acetate copolymers, ethylene acrylate copolymers, ethylene methacrylate copolymers, ethylene acrylate glycidyl-acrylate copolymers. The amount of ethylene unit can range from 50% to 95% by weight and the remaining the other monomer in the copolymer. The preferred copolymer is ethylene-vinyl acetate. The vinyl acetate content can vary from 2% to 30% by weight in the copolymer. These copolymers have co-monomers which are relatively more polar than ethylene which improve the interfacial compatibility with the inert fillers and glass beads in the thermoplastic core. The amount of the copolymer can be varied in the composition to improve the toughness without substantial increase in melt viscosity and softening point of the thermoplastic core material.

### Glass Beads

A wide variety of reflective beads can be used in the present invention. Such beads include microspheres formed of glass materials. The retroreflectivity of the beads depends on the refractive index of the beads, the bead size, roundness, air inclusion, binder and the depth of the bead embedment on the core. These reflective beads have a refractive index in the range 1.2 to 2.6, preferably higher than 1.5. These glass beads are available in different sizes in the range 45 to 1400 microns. The commercially available beads are largely spherical with a small amount of oblong shaped beads. It is preferable to have higher amount of spherical beads for higher retro-reflectivity of the optical elements. The reflective beads preferably have a diameter compatible with the size, shape and geometry of the core material. The glass beads present in the thermoplastic core and the beads embedded on the core can be the same or different depending on the use condition. However, the embedded beads usually have higher refractive index than the refractive index of the beads present in the thermoplastic core. The embedded beads should have sufficient hardness to withstand the road traffic.

The virgin glass beads are hydrophilic and have high surface energy, do not mix easily with the low surface energy hydrophobic thermoplastic core material. These glass beads exhibit poor wetting with the core and also have a heterogeneous interface between the thermoplastic core and the embedded beads due to the large differences in the surface energy. This may result in less than desired level of embedment in the core and poor bonding with the core, often resulting in the removal of the embedded beads due to the road traffic and reduces the retroreflectivity of the optical elements. However there are glass beads available commercially with surface coatings. The surface coatings can either reduce the moisture absorption of the beads or can improve adhesion with road marking paint. The coating is proprietary, which generally comprises fluoro or silicone polymers applied to the glass spheres to reduce the moisture absorption or the silane or titanate or zirconate and other organic compounds to improve the adhesion. The common road striping paints are based on thermoplastic, such as acrylic lattices, polyurea, epoxy resins and polymethylmethacrylate. The type of striping paints used in a location depends on the local weather and traffic, varies a lot in the same region, county, state and country. There are no known coating combination for a specific type of the road marking paint and industry knowledge to select beads either for moisture absorption or adhesion promotion or a combination of both.

### Embedment of the Glass Beads on the Thermoplastic Core

The process of attaching the optical element with the thermoplastic core can be accomplished by heating the reflecting glass beads close to the softening temperature of the thermoplastic core, mixing the hot glass beads with the pellets of the thermoplastic core kept at room temperature for a short time and then isolating the excess free reflective beads in a separate stage. Such process can be accomplished using a fluidized bed, a rotary kiln, a tumbler etc. The mixing time is short, ranging from 30 seconds to five minutes, preferably from two to four minutes. The reflective element has to wet the thermoplastic core, embed onto the thermoplastic core to required depth in the short reaction time. The embedment of the reflective elements in to the core occurs by wicking action and is important because the core material forms like a socket structure around each glass bead and holds it in place. The proper selection of the ingredients in the thermoplastic core and the surface modification of the reflective elements plays important roles for the both phenomena, wetting and embedment, to occur in short reaction times. In addition, it is also critical to select the ingredients in the core and the surface coatings on the reflective elements capable of reacting and forming chemical bonds in the short reaction time. The embedment depth of the glass beads in the thermoplastic core depends on the softening point and viscosity of the thermoplastic core, and the reaction temperature of the process.

The process of adding the thermoplastic core material, maintained at room temperature, to a mobile bed of heated reflective elements allows the reflective elements embed to a majority of the surface area of the core thermoplastic material. The reflective elements are heated preferably close to the softening point of the core, to either exactly to the softening point or one to two degrees lower or higher than the softening point of the core. Heating of the reflective glass beads far below the softening point of the thermoplastic may result in non-uniform coverage of the glass beads on the core material. Heating the reflective elements far above the softening point of the core may result in fusing of the core material, resulting optical elements with a broad size distribution.

The process reaction time for embedding the reflective beads on the thermoplastic core is short, within a few minutes. Within this time, the reflective beads should wet with the thermoplastic core, embed sufficiently on the core and form chemical bonds. Therefore it is necessary that the thermoplastic core and the surface modification of glass beads have suitable functional groups and favorable reaction kinetics to form strong chemical bonds within the short reaction time. No strong chemical bond formation is possible, only weak secondary interactions possible if either one of the components does not have suitable organic functional group. The possible chemical bond formation should happen at the embedment temperature and within the reaction time.

The covalent bond is the strongest among the possible different bonds between the thermoplastic core and the inorganic glass beads. The covalent bond formation is not feasible if the ingredients in the thermoplastic core or the chemical modification do not have suitable functional groups. There is considerable amount of flexibility in selecting an ingredient with organic functional group in one of the constituents of the thermoplastic core. Alternately among the available coupling agents or organic modification of glass beads, only select silane coupling agents are available with different organic functional groups. Silane coupling agents having functional groups such as amine, acryl, imine, epoxy, isocyanato, mercaptan and salts of acids can be used in the present invention. Suitable examples are aminopropyltriethoxy silane, aminophenytriethoxy silane, acrylamidopropyltrimethoxy silane, acryloxypropylmethyldimethoxy silane, 3-(N-allylamino)propyltrimethoxy silane, bis(triethoxypropyl) amine, 2-(carboxymethoxy)ethyltrimethoxy silane, glycidoxypropyltriethoxy silane, 2-(3,4)-epoxycyclohexylethyltriethoxy silane, 3-isocyanatopropyltriethoxy silane, 3-mercaptopropyltriethoxy silane, methacryloxypropyltriethoxy silane, tirmethoxysilylpropyl modified polyethylene imine, N-(trimethoxysilylpropyl)ethylenediamine triacetic acid sodium salt, N(3-triethoxysilylpropyl)-4,5-dihyrdroimidazole, vinyltriethoxy silane and the like. The titanate and zirconate coupling agents do not have any freely available functional groups to react with the thermoplastic core.

Without being bound to any particular theory, it is also possible through appropriate selection of the thermoplastic core and glass beads sufficient compressive forces can be developed so that the thermoplastic core locks tightly to the glass beads. Because of the presence of organic binders, the thermoplastic core is expected to have a higher coefficient of thermal expansion than the inorganic glass beads. Upon cooling to ambient temperature from the embedment reaction temperature to ambient, the thermoplastic core contracts more than the glass beads and the resultant compressive force locks the beads tightly. Since the force due to contraction is a product of the modulus of the thermoplastic, the differences in the coefficient of thermal expansions and the temperatures, the compressive force can be enhanced by increasing the modulus of the core by using inert fillers in the thermoplastic.

### EXAMPLES

Table 1 below lists the ingredients for the preparation of optical elements used in the examples listed below. The Sylvacote 4984 is a maleic modified rosin resin, having an anhydride functional groups for reaction with the functional groups present in the silane couplings used for the surface modification of the glass beads. The acid number of Sylvacote 4984 is 38 mg KOH/g, The Indorez C5 HMRM resin is a hydrogenated hydrocarbon resin, free from any organic functional groups. The product acid value is less than 0.1 mg KOH/g, indicating very little amount of acid group present in the resin.

TABLE 1

| Material description | Trade designation | Supplier |
|---|---|---|
| Alky resin | Sylvacote 4984 | Kraton Chemical, Savannah, GA |
| Castor oil | | Integrated Traffic Solutions, Houston TX |
| PE Onwax | Onwax PE 600200P | Integrated Traffic Solutions, Houston TX |
| EVA Copolymer | Primeva P284000 | Integrated Traffic Solutions, Houston TX |
| Titanium dioxide | Tiona 595 | Cristal USA, Ashtabula, OH |
| Calcium carbonate | KW125 | Kish Company Inc. Mentor OH |
| Glass beads | M247, FLX 1.9T 100-140mesh | Potters Industries, Brownwood TX |
| Silane coupling agents | SIA0610.0, SIG5840.0 | Gilest Inc., Morrisville PA |
| Indorez C5 Hydrocarbon resin | Grade HMRM | Integrated Chemical Specialties, Houstong TX |

The softening point of the thermoplastic composition was measured using the ring and ball apparatus using ASTM D36 method.

The viscosity of the thermoplastic composition was measured using CALTRANS method at 425° F. with a spindle SC4-27 at 20 rpm. A Thermosel disposal aluminum spindle and chamber were used for the measurement.

The energy to break (toughness) of the thermoplastic composition was measured using a three point bend test as reported in ASTM D0790-17. The dimension of the test bar used in the tests is 6″×½″×¼″. The area under the stress-strain curve is computed and reported as average energy to break, which is a measure of the toughness of the thermoplastic.

The surface modification of the glass beads by silane coupling agents, aminopropyltriethoxysilane (amino silane) and (3-glycidoxypropyl)trimethoxysilane (epoxy silane), was carried out using the procedure “Deposition form Aqueous Alcohol” reported in the Gilest (Gilest Inc., 11 East Steel Road, Morrisville, Pa. 29067) catalogues. A two part of the coupling agent was used for the hundred parts of the glass beads for the surface modification. The epoxy silane solution was acidified using acetic acid to pH 4-5 before applying to the glass beads.

The embedment of surface modified glass beads was done in a fluidized bed set up. The fluidized bed chamber was equipped with a heated tube through which air is blown at 6-8 liters per minute to heat and agitate the glass beads. 60 grams of the glass bead was charged in the chamber and heated using the hot air flow to within ±1° C. of the softening point of the respective thermoplastic pellets to be embedded. After reaching the steady temperature of the beads, 20 grams of the thermoplastic pellets kept at room temperature were added and mixed for three minutes. The contents were then transferred to a 50 mesh screen and sieved to isolate the optical elements.

Sherwin Williams Hotline TM2152 White fast dry water-born traffic paint was used to make the coating. A 4.5″ wide coating was made on a 6″ wide and 18″ length glass plate. The wet coating thickness was in the range 35-40 mil. This coating was used for the abrasion resistance experiment to test the durability of the optical elements.

The retro-reflectivity of the optical elements on a draw down coating was measured using a portable Delta (Denmark) LTL-X Retro-meter and the retroreflectivity was expressed in the unit mcd/m²/lx.

The durability of the glass beads embedment in the core was measured using the wet abrasive resistance as reported in ASTM D2486-96. Coatings made using the optical elements made using this invention were subjected to wet abrasion resistance in a Sheen Wet Abrasion Scrub Tester. Brass brush was used as the scrubber, water as the wet medium and the number of strokes was 7000. The retroreflectivity of the coatings before and after abrasion testing, i.e., the retained retroreflectivity, was taken as a measure of the durability of the glass beads embedment in the thermoplastic core.

### Example 1: Toughness Thermoplastic Composition

The amount of ethylene copolymer was varied without changing much on the total binder content in the thermoplastic composition. The increase in the copolymer content was compensated by a similar reduction in the inert filler calcium carbonate.

The binder ingredients in the following table was weighed in a one pint can and heated on a hot plate with constant stirring using a mechanical stirrer. Once the melt was clear, then titanium oxide, calcium carbonate and the glass beads were weighed in the sequence described and added sequentially until the previously added filler dispersed very well. Then the melt was heated to 400° F. to 410° F., held at this temperature for at least ten minutes. The melt was poured in a Teflon pan and allowed to cool. The chips of the thermoplastic was melted again in a tin can to 400° F. and poured onto a silicone mold having rectangle slots of this dimension 12″ length, ½″ width and ¼″ depth. The excess melt on the mold was removed using a metal squeegee. After cooling down, the test bars were removed, cut into 6″ length bars for measuring the toughness.

As shown in Table 2 below, the properties of the compositions showed clearly that the toughness improved by seven times by increasing the amount of copolymer by three times. However, the melt viscosity and the softening temperature remained in the same range even with increasing the copolymer content by three times.

TABLE 2

| | | | |
|---|---|---|---|
| Ingredients | 2.5% EVA | 5.0% EVA | 7.5% EVA |

Compositions

| | | | |
|---|---|---|---|
| Sylvacote | 13.86 | 13.86 | 13.86 |
| Castor oil | 1.30 | 1.30 | 1.30 |
| PE Wax | 3.00 | 3.00 | 3.00 |
| Ethylene-vinyl acetate | 2.50 | 5.00 | 7.50 |
| copolymer | | | |
| Titanium oxide | 10.00 | 10.00 | 10.00 |
| Calcium carbonate | 17.34 | 14.84 | 12.34 |
| M247 glass beads | 52.00 | 52.00 | 52.00 |
| Total | 100.00 | 100.00 | 100.00 |

Properties

| | | | |
|---|---|---|---|
| Melt viscosity (cps, @425° | 4188 | 5418 | 5925 |
| F., 20 rpm | | | |
| Softening point (° F.) | 213 | 215 | 212 |
| Ave. energy to break (KPa) | 77 ± 16 | 263 ± 50 | 540 ± 87 |

### Example 2: Reactive Thermoplastic Compositions

Reactive compositions having higher and lower toughness prepared as shown in Table 3 below were melted in a tin can as described in Example 1 to measure their properties. The melt viscosity and the softening temperature of the two compositions remained in the same range even with the three-fold change in the copolymer amount.

TABLE 3

| Ingredients | Higher toughness | Lower toughness |
|---|---|---|
| Sylvacote | 13.86 | 13.86 |
| Castor oil | 1.30 | 1.30 |
| PE Wax | 3.00 | 3.00 |
| Ethylene-vinyl acetate copolymer | 7.50 | 2.50 |
| Titanium oxide | 10.00 | 10.00 |
| Calcium carbonate | 42.34 | 47.34 |

Properties

| | | |
|---|---|---|
| Melt viscosity (cps, @425° | 7488 | 6800 |
| F., 20 rpm) | | |
| Softening point (° F.) | 212 | 218 |

The ingredients of these two compositions were mixed in powder form and melt extruded at 85° C. in a Thermo Scientific Process 11 Twin Screw Extruder, equipped with a 3 mm die using conventional melt processing techniques. The diameter of the strands was 1.97 mm and 1.92 mm for the higher and lower toughness compositions. The strands were cut into pellets of 2 mm to 3 mm in length.

### Example 3: Non-Reactive Thermoplastic Composition

The ingredients of this composition shown in Table 4 below were mixed in powder form and melt extruded at 65° C. in the twin screw extruder. The same high amount of ethylene copolymer was used to maintain the toughness. The diameter of the strand was 1.92 mm, and pellets cut from the strand were 2 mm to 3 mm in length.

TABLE 4

| Ingredients | Amount |
|---|---|
| Indorez | 13.86 |
| Castor oil | 1.30 |
| PE Wax | 3.00 |
| Ethylene-vinyl acetate copolymer | 7.50 |
| Titanium oxide | 10.00 |
| Calcium carbonate | 42.34 |

Properties

| | |
|---|---|
| Melt viscosity (cps, @425° F., 20 rpm) | 4387 |
| Softening point (° F.) | 201 |

### Example 4: Retroreflectivity of Optical Elements after Wet Abrasion Testing

18.1 g of the optical element was weighed and spread along the length of the bead channel uniformly in a drop box to spread the elements on the coating. This amount corresponds to 8 pounds of optical elements for a gallon of paint. The white coating was made on a 6″×18″ glass panel using doctor blade with 50 mil opening. As soon as the coating was made, the element was dropped from the box to uniformly spread and embed on the coating. The wet thickness of the coating was in the range 35-40 mil.

The retroreflectivity was measured after drying the coating overnight at room temperature. Then the coating was subjected to wet abrasion testing with a minimum of 7000 strokes. The coating was washed with water to remove the debris. The retroreflectivity was measured after drying the coating overnight.

Tables 5, 6, and 7 below respectively report the retroreflectivity after wet abrasion showing (i) the effect of coupling agent modification; (ii) the effect of thermoplastic core toughness; and (iii) the effect of reactivity of the thermoplastic core.

Optical elements made using the higher toughness reactive thermoplastic were used to measure the effect of coupling agent modification on the durability of optical elements. As shown in Table 5 below, use of epoxy silane resulted in an increased retention of retroreflectivity.

TABLE 5

| Surface modification | Retro reflectivity | | Retained retro |
|---|---|---|---|
| on glass beads | Before abrasion | After abrasion | reflectivity (%) |
| None | 1882 | 917 | 48 |
| Amino silane | 1920 | 955 | 50 |
| Epoxy silane | 1841 | 1201 | 65 |

Optical elements made using epoxy silane modified glass beads were used to measure the effect of the thermoplastic core toughness on the durability of the optical elements. As shown in Table 6 below, optical elements having a higher toughness showed greater retention of retroreflectivity.

TABLE 6

| Toughness of the | Retro reflectivity | | Retained retro |
|---|---|---|---|
| thermoplastic core | Before abrasion | After abrasion | reflectivity (%) |
| Low | 2076 | 834 | 40 |
| High | 1841 | 1201 | 65 |

Optical elements made using epoxy silane modified glass beads were used to measure the effect of the reactivity of the thermoplastic core on the durability of the optical elements. As shown in Table 7 below, optical elements having a reactive core had a greater retention of retroreflectivity than optical elements having a non-reactive core.

TABLE 7

| Reactivity of the | Retro reflectivity | | Retained retro |
|---|---|---|---|
| thermoplastic core | Before abrasion | After abrasion | reflectivity (%) |
| Non-reactive | 1583 | 632 | 40 |
| Reactive | 1841 | 1201 | 65 |

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range, including the endpoints.

What is claimed is:

1. A retroreflective optical element comprising a reactive thermoplastic core and at least one modified glass bead having a high refractive index embedded on the surface of said thermoplastic core.

2. The retroreflective optical element of claim 1, wherein said modified glass bead is chemically bonded to said thermoplastic core.

3. The retroreflective optical element of claim 2, wherein said thermoplastic core comprises a maleic modified rosin resin.

4. The retroreflective optical element of claim 3, wherein said modified glass bead comprises a coupling agent.

5. The retroreflective optical element of claim 4, wherein said coupling agent is a silane coupling agent.

6. The retroreflective optical element of claim 5, wherein said silane coupling agent has a functional group selected from the group consisting of amine, acryl, imine, epoxy, isocyanato, mercaptan and salts of acids.

7. The retroreflective optical element of claim 5, wherein said silane coupling agent is selected from the group consisting of aminopropyltriethoxy silane, aminophenytriethoxy silane, acrylamidopropyltrimethoxy silane, acryloxypropylmethyldimethoxy silane, 3-(N-allylamino)propyltrimethoxy silane, bis(triethoxypropyl) amine, 2-(carboxymethoxy)ethyltrimethoxy silane, glycidoxypropyltriethoxy silane, 2-(3,4)-epoxycyclohexylethyltriethoxy silane, 3-isocyanatopropyltriethoxy silane, 3-mercaptopropyltriethoxy silane, methacryloxypropyltriethoxy silane, tirmethoxysilylpropyl modified polyethylene imine, N-(trimethoxysilylpropyl)ethylenediamine triacetic acid sodium salt, N(3-triethoxysilylpropyl)-4,5-dihyrdroimidazole, and vinyltriethoxy silane.

8. A process for manufacturing optical elements comprising the steps of
a. providing a plurality of reactive thermoplastic pellets and a plurality of modified glass beads into a fluidized bed;
b. heating said modified glass beads to a temperature near the softening point of said thermoplastic pellets;
c. mixing said heated beads with said thermoplastic pellets, whereby said glass beads embed within said thermoplastic pellets to form said optical elements; and
d. sieving the mixture to isolate said optical elements.

9. The process of claim 8, wherein said beads are embedded into said thermoplastic pellets into a depth of at least 30% and at most 70%.

10. The process of claim 8, wherein said beads are mixed with said thermoplastic pellets for a time between 30 seconds and 5 minutes.

11. The process of claim 8, wherein said modified glass bead is chemically bonded to said thermoplastic pellet.

12. The process of claim 11, wherein said thermoplastic pellet comprises a maleic modified rosin resin.

13. The process of claim 12, wherein said modified glass bead comprises a coupling agent.

14. The process of claim 13 wherein said coupling agent is a silane coupling agent.

15. The process of claim 14 wherein said silane coupling agent has a functional group selected from the group consisting of amine, acryl, imine, epoxy, isocyanato, mercaptan and salts of acids.

16. The process of claim 14 wherein said silane coupling agent is selected from the group consisting of aminopropyltriethoxy silane, aminophenytriethoxy silane, acrylamidopropyltrimethoxy silane, acryloxypropylmethyldimethoxy silane, 3-(N-allylamino)propyltrimethoxy silane, bis(tri ethoxypropyl) amine, 2-(carboxymethoxy)ethyltrimethoxy silane, glycidoxypropyltriethoxy silane, 2-(3,4)-epoxycyclohexyl ethyltriethoxy silane, 3-isocyanatopropyltriethoxy silane, 3-mercaptopropyltriethoxy silane, methacryloxypropyltriethoxy silane, tirmethoxysilylpropyl modified polyethylene imine, N-(trimethoxysilylpropyl)ethylenediamine triacetic acid sodium salt, N(3-triethoxysilylpropyl)-4,5-dihyrdroimidazole, and vinyltriethoxy silane.
